(19) United States
(12) Patent Application Publication
(10) Pub. No.: US 2025/0366658 A1
(43) Pub. Date: Dec. 4, 2025

(54) DOUBLE-SIDED HEATING APPARATUS

(71) Applicant: I/O Controls Corp., Azusa, CA (US)

(72) Inventors: ZHONG-HONG SU, FOSHAN CITY (CN); Andy Mei-Yu Shih, Azusa, CA (US)

(21) Appl. No.: 18/806,652

(22) Filed: Aug. 15, 2024

(30) Foreign Application Priority Data
May 29, 2024 (CN) 202410677315.3

(51) Int. Cl. A47J 37/06; A47J 27/00; A47J 36/32; F24C 15/00; H05B 6/10; H05B 6/12

(52) U.S. Cl. CPC A47J 37/0611; A47J 27/004; A47J 36/32; F24C 15/006; H05B 6/105; H05B 6/1209; A47J 2202/00; H05B 2213/07

(57) ABSTRACT

A double-sided heating apparatus includes a base module, a hot-pressing module, and a control module. The base module includes a seat assembly having a first cooking surface, and a first heating assembly configured to drive the first cooking surface to generate heat energy. The hot-pressing module includes a cover assembly having a second cooking surface, and a second heating assembly configured to drive the second cooking surface to generate heat energy. The cover assembly is movably connected to the seat assembly. The control module is configured to control one or both of the first heating assembly and the second heating assembly to actuate. When the first cooking surface carries a food ingredient, and the cover assembly covers the seat assembly, the first cooking surface and the second cooking surface clamp and heat the food ingredient, such that heating and cooking efficiencies of the double-sided heating apparatus are enhanced.

### CROSS-REFERENCE TO RELATED PATENT APPLICATION

This application claims the benefit of priority to China Patent Application No. 202410677315.3, filed on May 29, 2024, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a double-sided heating apparatus, and more particularly to a double-sided heating apparatus that can uniformly heat both surfaces of a food ingredient.

### BACKGROUND OF THE DISCLOSURE

Griddles currently available on the market are mostly designed to be a single-sided heating type, and a circular heating tube is installed at a bottom portion of the griddle to act as a heat source. However, such a griddle has disadvantages of low efficiency in heat energy, slowness in heating of the griddle, difficulty in replacement of the damaged heating tube, etc.

Therefore, how to overcome the above-mentioned problems through improvements in structural design has become one of the important issues to be solved in the relevant industry.

### SUMMARY OF THE DISCLOSURE

In response to the above-referenced technical inadequacies, the present disclosure provides a double-sided heating apparatus, so as to achieve characteristics of efficient heating, rapid cooking, and durability in use.

In order to solve the above-mentioned problems, one of the technical aspects adopted by the present disclosure is to provide a double-sided heating apparatus, which includes a base module, a hot-pressing module, and a control module. The base module includes a seat assembly and a first heating assembly. The seat assembly has a first accommodating space and a first cooking surface. The first cooking surface is configured to carry at least one food ingredient. The first heating assembly is disposed in the first accommodating space. The first heating assembly corresponds to the first cooking surface, and is configured to drive the first cooking surface to generate heat energy. The hot-pressing module includes a cover assembly and a second heating assembly. The cover assembly is movably connected to the seat assembly. The cover assembly has a second accommodating space and a second cooking surface, and the second cooking surface corresponds to the first cooking surface. The second heating assembly is disposed in the second accommodating space, and is connected to the control module. The second heating assembly corresponds to the second cooking surface, and is configured to drive the second cooking surface to generate heat energy. The control module is connected to the first heating assembly and the second heating assembly. The control module is configured to control one or both of the first heating assembly and the second heating assembly to actuate. When the first cooking surface of the seat assembly carries the at least one food ingredient, and the cover assembly covers the seat assembly, the first cooking surface and the second cooking surface clamp and heat the at least one food ingredient.

In one of the possible or preferred embodiments, the control module includes a first driving assembly, a second driving assembly, and at least one processing assembly. The first driving assembly is connected to the first heating assembly, and is configured to control the first heating assembly for driving the first cooking surface to generate the heat energy. The second driving assembly is connected to the second heating assembly, and is configured to control the second heating assembly for driving the second cooking surface to generate the heat energy. The at least one processing assembly is connected to the first driving assembly and the second driving assembly. According to an execution instruction, the at least one processing assembly is configured to control one or both of the first driving assembly and the second driving assembly for respectively driving the first heating assembly and the second heating assembly to actuate.

In one of the possible or preferred embodiments, the first heating assembly includes a first thermal insulation component, a first heat-generating component, and a first carrier component. The first thermal insulation component corresponds to the first cooking surface. The first heat-generating component is connected to the first driving assembly, and is configured to provide a first electromagnetic field for driving the first cooking surface to generate the heat energy. The first carrier component is configured to carry the first heat-generating component. The first heat-generating component is disposed between the first thermal insulation component and the first carrier component.

In one of the possible or preferred embodiments, the first carrier component has a plurality of ventilation openings, and the ventilation openings correspond to the first heat-generating component. The first driving assembly includes a first mechanical component and a first heat dissipation component. The first mechanical component is connected to the at least one processing assembly and the first heat-generating component, and is configured to control the first heat-generating component to provide the first electromagnetic field. The first heat dissipation component is connected to the at least one processing assembly. The first heat dissipation component corresponds to one of the ventilation openings, and is configured to provide a heat dissipation airflow to the one of the ventilation openings. The second driving assembly includes a second mechanical component and a second heat dissipation component. The second mechanical component is connected to the at least one processing assembly and the second heating assembly. The second mechanical component is configured to control the second heating assembly for driving the second cooking surface to generate the heat energy. The second heat dissipation component is connected to the at least one processing assembly. The second heat dissipation component corresponds to another one of the ventilation openings, and is configured to provide the heat dissipation airflow to the another one of the ventilation openings.

In one of the possible or preferred embodiments, the second heating assembly includes a second thermal insulation component, a second heat-generating component, and a second carrier component. The second thermal insulation component corresponds to the second cooking surface. The second heat-generating component is connected to the second driving assembly, and is configured to provide a second electromagnetic field for driving the second cooking surface to generate the heat energy. The second carrier component is configured to carry the second heat-generating component. The second heat-generating component is disposed between the second thermal insulation component and the second carrier component.

In one of the possible or preferred embodiments, the second heat-generating component includes a first blocking member, a heat-inducing member, a second blocking member, and a plurality of magnetic members. The first blocking member is disposed on a surface of the second thermal insulation component. The heat-inducing member is disposed on a surface of the first blocking member that faces away from the second thermal insulation component. The heat-inducing member is connected to the second driving assembly, and is configured to provide the second electromagnetic field. The second blocking member is disposed on a surface of the heat-inducing member that faces away from the first blocking member. The magnetic members are disposed on a surface of the second blocking member that faces away from the heat-inducing member.

In one of the possible or preferred embodiments, the base module further includes a first sensing assembly. The first sensing assembly is disposed on the seat assembly, and is connected to the at least one processing assembly. The first sensing assembly is configured to sense a temperature of the first cooking surface. The hot-pressing module further includes a second sensing assembly. The second sensing assembly is disposed on the cover assembly, and is connected to the at least one processing assembly. The second sensing assembly is configured to sense a temperature of the second cooking surface. The control module further includes a display assembly, and the display assembly is disposed on the seat assembly and connected to the at least one processing assembly. The at least one processing assembly is configured to drive the display assembly to display at least one temperature message according to one or both of a result of the first sensing assembly sensing the temperature of the first cooking surface and a result of the second sensing assembly sensing the temperature of the second cooking surface. The at least one temperature message is numbers, characters, or a combination thereof.

In one of the possible or preferred embodiments, the seat assembly includes a housing component and a first griddle component, the housing component has the first accommodating space, the first griddle component is embedded in the housing component, and a surface of the first griddle component is the first cooking surface. The cover assembly includes a cover component and a second griddle component. The cover component has the second accommodating space, and is movably connected to the seat assembly. The second griddle component is connected to the cover component, and a surface of the second griddle component is the second cooking surface.

In one of the possible or preferred embodiments, the cover component includes an outer housing, a frame, and a plurality of support members. The outer housing has the second accommodating space, and is connected to the second griddle component. The frame is movably connected to the outer housing. One end of each of the support members is connected to the frame, and another end of each of the support members is connected to the housing component.

In one of the possible or preferred embodiments, the seat assembly further includes a heat removal component. The heat removal component is embedded in the housing component, and is connected to the control module. The heat removal component is configured to draw and discharge gas in the first accommodating space outside of the housing component.

Therefore, in the double-sided heating apparatus provided by the present disclosure, by virtue of “the base module including a seat assembly and a first heating assembly, the seat assembly having a first accommodating space and a first cooking surface, and the first cooking surface being configured to carry at least one food ingredient,” “the first heating assembly being disposed in the first accommodating space, the first heating assembly corresponding to the first cooking surface, and the first heating assembly being configured to drive the first cooking surface to generate heat energy,” “the hot-pressing module including a cover assembly and a second heating assembly, the cover assembly being movably connected to the seat assembly, the cover assembly having a second accommodating space and a second cooking surface, and the second cooking surface corresponding to the first cooking surface,” “the second heating assembly being disposed in the second accommodating space and connected to the control module, the second heating assembly corresponding to the second cooking surface, and the second heating assembly being configured to drive the second cooking surface to generate heat energy,” “the control module being connected to the first heating assembly and the second heating assembly, and the control module being configured to control one or both of the first heating assembly and the second heating assembly to actuate,” and “the first cooking surface and the second cooking surface clamping and heating the at least one food ingredient when the first cooking surface of the seat assembly carries the at least one food ingredient and the cover assembly covers the seat assembly,” heating and cooking efficiencies can be enhanced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a double-sided heating apparatus according to a first embodiment of the present disclosure;

FIG. 2 is a schematic exploded view of a base module and a control module of the double-sided heating apparatus according to the first embodiment of the present disclosure;

FIG. 3 is a schematic exploded view of a hot-pressing module of the double-sided heating apparatus according to the first embodiment of the present disclosure;

FIG. 4 is another schematic perspective view of the double-sided heating apparatus according to the first embodiment of the present disclosure;

FIG. 5 is a functional block diagram of the double-sided heating apparatus according to the first embodiment of the present disclosure;

FIG. 6 is a schematic view showing a first use status of the double-sided heating apparatus according to the first embodiment of the present disclosure;

FIG. 7 is a schematic view showing a second use status of the double-sided heating apparatus according to the first embodiment of the present disclosure;

FIG. 8 is a partial schematic exploded view of the hot-pressing module of the double-sided heating apparatus according to a second embodiment of the present disclosure;

FIG. 9 is a functional block diagram of the double-sided heating apparatus according to the second embodiment of the present disclosure;

FIG. 10 is a partial schematic exploded view of the hot-pressing module of the double-sided heating apparatus according to a third embodiment of the present disclosure; and

FIG. 11 is a schematic view showing a use status of the double-sided heating apparatus according to the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

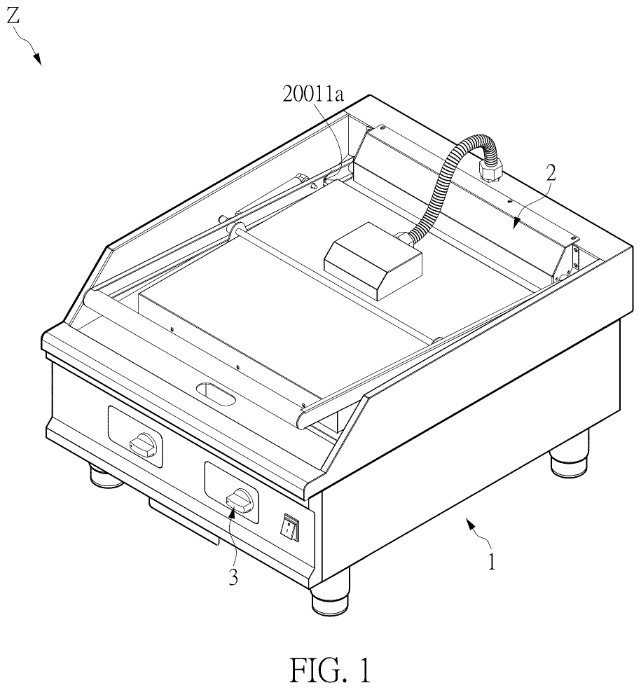

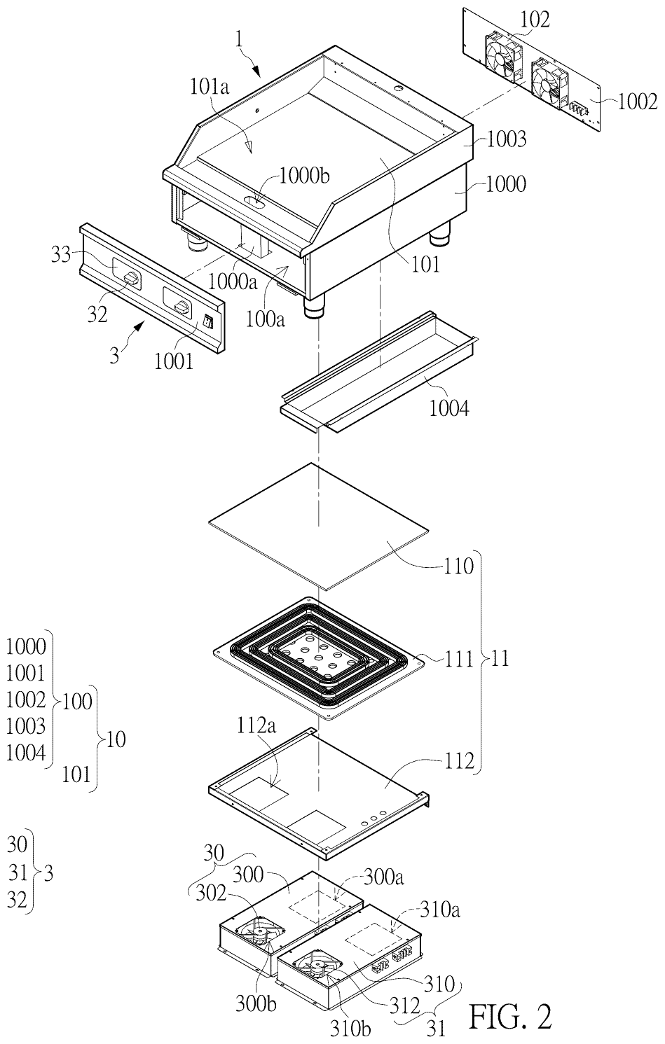

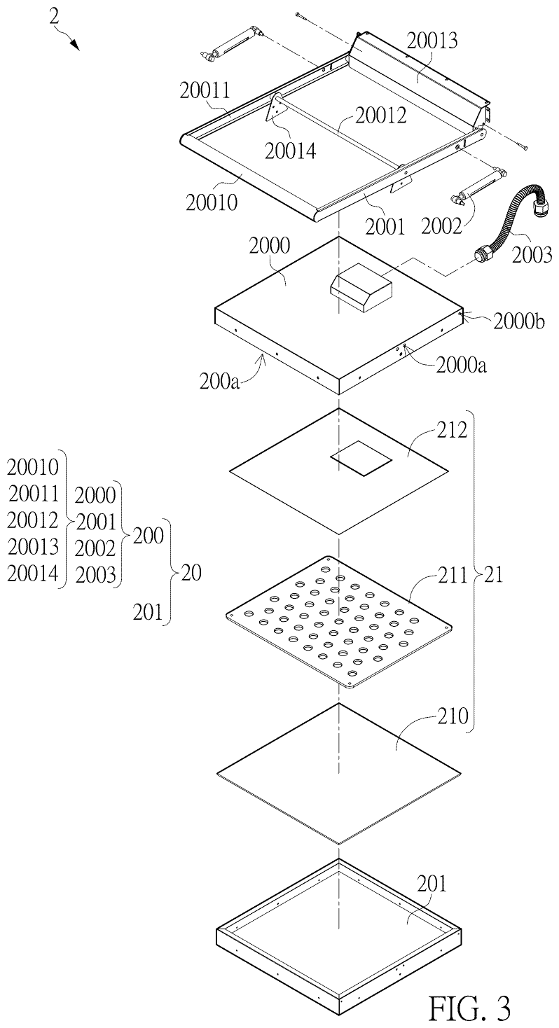

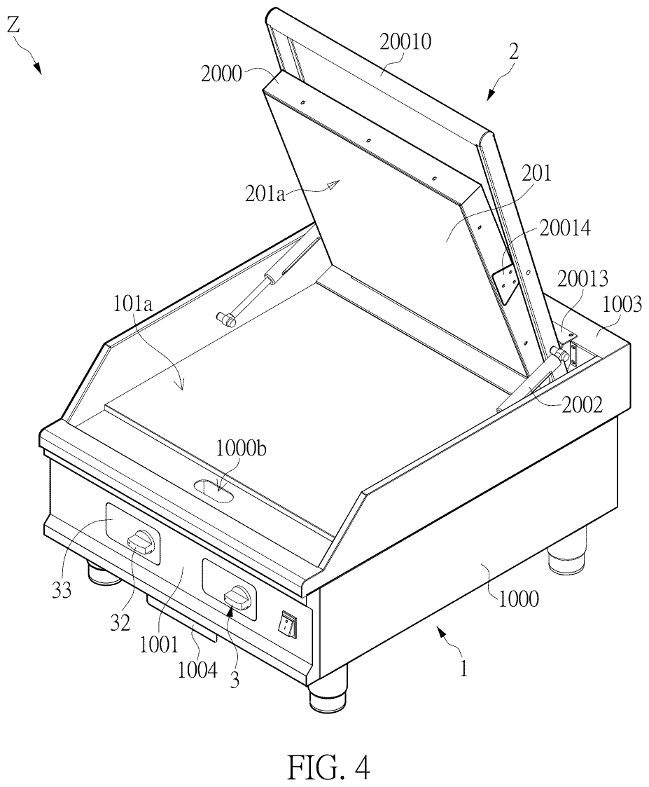

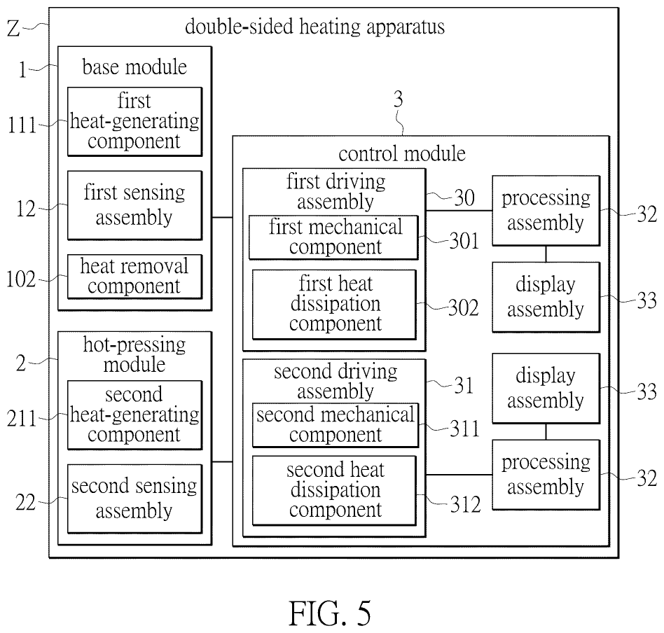

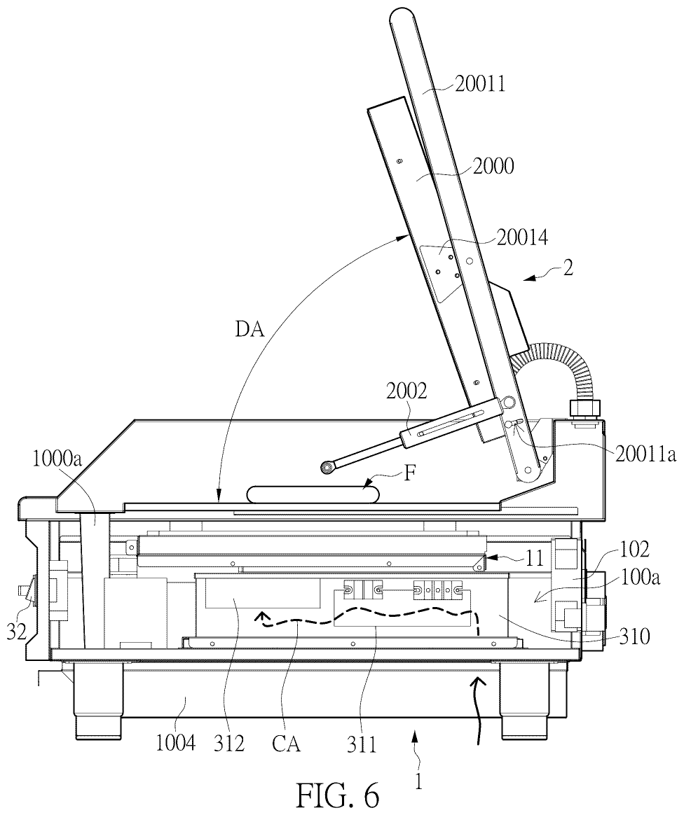

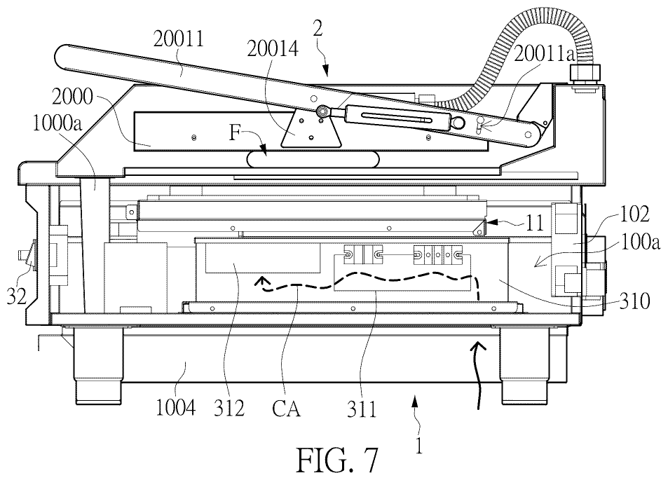

Referring to FIG. 1 to FIG. 7, FIG. 1 is a schematic perspective view of a double-sided heating apparatus according to a first embodiment of the present disclosure, FIG. 2 is a schematic exploded view of a base module and a control module of the double-sided heating apparatus according to the first embodiment of the present disclosure, FIG. 3 is a schematic exploded view of a hot-pressing module of the double-sided heating apparatus according to the first embodiment of the present disclosure, FIG. 4 is another schematic perspective view of the double-sided heating apparatus according to the first embodiment of the present disclosure, FIG. 5 is a functional block diagram of the double-sided heating apparatus according to the first embodiment of the present disclosure, FIG. 6 is a schematic view showing a first use status of the double-sided heating apparatus according to the first embodiment of the present disclosure, and FIG. 7 is a schematic view showing a second use status of the double-sided heating apparatus according to the first embodiment of the present disclosure. As shown in the figures mentioned above, the first embodiment of the present disclosure provides a double-sided heating apparatus Z, which includes a base module 1, a hot-pressing module 2, and a control module 3.

As shown in FIG. 1, FIG. 2, and FIG. 4 to FIG. 7, the base module 1 includes a seat assembly 10 and a first heating assembly 11. The seat assembly 10 has a first accommodating space 100a and a first cooking surface 101a. The first cooking surface 101a is configured to carry at least one food ingredient F. The food ingredient F can be, for example, meat, but is not limited thereto. The first heating assembly 11 is disposed in the first accommodating space 100a. The first heating assembly 11 corresponds to the first cooking surface 101a, and is configured to drive the first cooking surface 101a to generate heat energy. For example, the seat assembly 10 includes a housing component 100 and a first griddle component 101. The housing component 100 can be a hollow base structure made of a metal material, and has the first accommodating space 100a. The first griddle component 101 can be a plate structure made of a conductive and magnetic material, and is embedded in the housing component 100. One surface of the first griddle component 101 is the first cooking surface 101a. Here, the first griddle component 101 is embedded in an upper portion of the housing component 100, and the first cooking surface 101a of the first griddle component 101 is exposed from the housing component 100. Another surface of the first griddle component 101 is exposed in the first accommodating space 100a, and corresponds to the first heating assembly 11.

Specifically, the housing component 100 includes a main housing 1000, a front housing plate 1001, a rear housing plate 1002, a shielding member 1003, and a collection member 1004. The main housing 1000 can be a hollow base structure made of a metal material, and has the first accommodating space 100a. The main housing 1000 includes a guide channel structure 1000a that penetrates through its main body. The guide channel structure 1000a can be a hollow columnar structure. That is to say, the guide channel structure 1000a is disposed in the first accommodating space 100a. While one end of the guide channel structure 1000a communicates with a surface of an upper portion of the main housing 1000 to form a guide opening 1000b, another end of the guide channel structure 1000a also communicates with a surface of a bottom portion of the main housing 1000 to form a discharge opening (not shown in the figures). The structure of the discharge opening and that of the guide opening 1000b are formed based on the same principle. The front housing plate 1001 is detachably connected to a side of one end of the main housing 1000, and the rear housing plate 1002 is detachably connected to a side of another end of the main housing 1000. The shielding member 1003 is detachably disposed on a surface of the main housing 1000 that corresponds to the hot-pressing module 2. The shielding member 1003 can be a housing structure that is made of a metal material and U-shaped. The collection member 1004 can be a collection trough or a collection container made of a metal material. The first heating assembly 11 includes a first thermal insulation component 110, a first heat-generating component 111, and a first carrier component 112. The first thermal insulation component 110 can be thermal insulation cotton, and corresponds to the first cooking surface 101a. The first heat-generating component 111 can be a heating coil assembly that is electromagnetic inductive, and is connected to the control module 3 (i.e., a first driving assembly 30 of the control module 3, which will be illustrated in detail below). The first heat-generating component 111 is configured to provide a first electromagnetic field for driving the first cooking surface 101a to generate the heat energy. Here, the first heat-generating component 111 is disposed between the first thermal insulation component 110 and the first carrier component 112, and an electromagnetic induction coil of the first heat-generating component 111 is square-shaped. In this way, the first heat-generating component 111 can have a large area and uniform heating. The first carrier component 112 can be a metal plate structure, and is configured to carry the first heat-generating component 111. A main body of the first carrier component 112 has a plurality of ventilation openings 112a, and the ventilation openings 112a correspond to the first heat-generating component 111.

As shown in FIG. 1 to FIG. 7, the hot-pressing module 2 includes a cover assembly 20 and a second heating assembly 21. The cover assembly 20 is movably connected to the seat assembly 10, and has a second accommodating space 200a and a second cooking surface 201a. The second cooking surface 201a corresponds to the first cooking surface 101a. The second heating assembly 21 is disposed in the second accommodating space 200a, and is connected to the control module 3. The second heating assembly 21 corresponds to the second cooking surface 201a, and is configured to drive the second cooking surface 201a to generate heat energy. For example, the cover assembly 20 includes a cover component 200 and a second griddle component 201. The cover component 200 can be a housing structure made of a metal material, and has the second accommodating space 200a. The cover component 200 is movably connected to the seat assembly 10. The second griddle component 201 can be a plate structure made of a conductive and magnetic material, and is connected to the cover component 200. One surface of the second griddle component 201 is the second cooking surface 201a. Here, the second griddle component 201 is embedded in a bottom portion of the cover component 200. The second cooking surface 201a of the second griddle component 201 is exposed from the cover component 200, and corresponds to the first cooking surface 101a. Another surface of the second griddle component 201 is exposed in the second accommodating space 200a, and corresponds to the second heating assembly 21.

Specifically, the cover component 200 includes an outer housing 2000, a frame 2001, and a plurality of support members 2002. The outer housing 2000 can be a housing structure made of a metal material, and has the second accommodating space 200a. The outer housing 2000 is connected to the second griddle component 201. That is, the second griddle component 201 is embedded in the outer housing 2000. The frame 2001 can be a frame structure made of a metal material, and is preferably B-shaped (but is not limited thereto). The frame 2001 is movably connected to the outer housing 2000. The support members 2002 can be hydraulic telescopic rods or other types of telescopic rods. One end of each support member 2002 is connected to the frame 2001, and another end thereof is connected to the housing component 100.

More specifically, the frame 2001 includes a handle support 20010, a plurality of side supports 20011, a middle support 20012, a connection support 20013, and a plurality of connection members 20014. The handle support 20010, the side supports 20011, and the middle support 20012 are rectangular-shaped and made of a metal material. The connection support 20013 can be a rectangular housing structure. The side supports 20011 are oppositely arranged, and correspond to two sides of the outer housing 2000. Each side support 20011 has a slide opening 20011a, and the slide opening 20011a can be a rectangular opening structure. Here, the one end of each support member 2002 is connected to a corresponding one of the side supports 20011. Two ends of the handle support 20010 are connected to one end of the side supports 20011, and two ends of the connection support 20013 are connected to another end of the side supports 20011. The slide opening 20011a is adjacent to another end of the side supports 20011. Two ends of the middle support 20012 are each connected to one of the side supports 20011, and the middle support 20012 is disposed between the handle support 20010 and the connection support 20013. The connection support 20013 is detachably connected to the main housing 1000 or the shielding member 1003. Each connection member 20014 can be a metal plate having a geometric shape (which is preferably triangular, but is not limited thereto). One end of each connection member 20014 is pivotally connected to one end of the middle support 20012. The two sides of the outer housing 2000 are oppositely arranged. A first connection point 2000a is disposed at a center position of each side of the outer housing 2000, and a second connection point 2000b is disposed at one end of each side of the outer housing 2000. Each first connection point 2000a is movably connected to another end of a corresponding one of the connection members 20014. Each second connection point 2000b is movably connected to a corresponding one of the slide openings 20011a. It is worth mentioning that the cover component 200 can further include a metal tube 2003, which is configured to accommodate wires for connecting a second heat-generating component 211 and a second mechanical component 311.

The second heating assembly 21 of the present disclosure includes a second thermal insulation component 210, the second heat-generating component 211, and a second carrier component 212. The second thermal insulation component 210 can be thermal insulation cotton, and corresponds to the second cooking surface 201a. The second heat-generating component 211 can be a heating coil assembly that is electromagnetic inductive, and is connected to the control module 3 (i.e., a second driving assembly 31 of the control module 3, which will be illustrated in detail below). The second heat-generating component 211 is configured to provide a second electromagnetic field for driving the second cooking surface 201a to generate the heat energy. Here, the second heat-generating component 211 is disposed between the second thermal insulation component 210 and the second carrier component 212, and an electromagnetic induction coil of the second heat-generating component 211 is square-shaped (similar to the first heat-generating component 111 of FIG. 1). In this way, the second heat-generating component 211 can have a large area and uniform heating, and does not need a fan for heat dissipation. The second carrier component 212 can be a metal plate structure, and is configured to carry the second heat-generating component 211.

As shown in FIG. 1 to FIG. 7, the control module 3 is connected to the first heating assembly 11 and the second heating assembly 12. The control module 3 is configured to control one or both of the first heating assembly 11 and the second heating assembly 21 to actuate. For example, the control module 3 includes the first driving assembly 30, the second driving assembly 31, and at least one processing assembly 32. The first driving assembly 30 is connected to the first heat-generating component 111 of the first heating assembly 11, and is configured to control the first heat-generating component 111 for driving the first cooking surface 101a to generate the heat energy. The second driving assembly 31 is connected to the second heat-generating component 211 of the second heating assembly 21, and is configured to control the second heat-generating component 211 for driving the second cooking surface 201a to generate the heat energy. The processing assembly 32 can be a control switch module (e.g., a controller) that is of a rotational type, a touch-screen type, or any other type. The processing assembly 32 is disposed on the front housing plate 1001 of the housing component 100. The processing assembly 32 is connected to the first driving assembly 30 and the second driving assembly 31. According to an execution instruction, the processing assembly 32 is configured to control one or both of the first driving assembly 30 and the second driving assembly 31 for respectively driving the first heat-generating component 111 and the second heat-generating component 211 to actuate. In the present embodiment, the quantity of the processing assembly 32 is exemplified to be two. While one of the processing assemblies 32 is configured to control the first driving assembly 30, another one of the processing assemblies 32 is configured to control the second driving assembly 31. However, the present disclosure is not limited thereto. In actual implementation, the double-sided heating apparatus Z of the present disclosure may include only one processing assembly 32, and the single processing assembly 32 is used for controlling the first driving assembly 30 and the second driving assembly 31.

Specifically, the first driving assembly 30 includes a first chassis component 300, a first mechanical component 301, and a first heat dissipation component 302. The first chassis component 300 can be a hollow structure, and has a first air inlet 300a and a first air outlet 300b. The first air inlet 300a is formed on one surface of the first chassis component 300, and corresponds to a bottom portion of the housing component 100. The first air outlet 300b is formed on another surface of the first chassis component 300, and corresponds to an upper portion of the housing component 100. The first mechanical component 301 is disposed in the first chassis component 300, and is connected to the processing assembly 32 and the first heat-generating component 111. The first mechanical component 301 is configured to control the first heat-generating component 111 to provide the first electromagnetic field. The first heat dissipation component 302 is disposed in the first chassis component 300, and is connected to the processing assembly 32. The first heat dissipation component 302 corresponds to the first air outlet 300b and one of the ventilation openings 112a. The first heat dissipation component 302 is configured to provide a heat dissipation airflow to the corresponding ventilation opening 112a. In addition, the second driving assembly 31 includes a second chassis component 310, a second mechanical component 311, and a second heat dissipation component 312. The second chassis component 310 can be a hollow structure, and has a second air inlet 310a and a second air outlet 310b. The second air inlet 310a is formed on one surface of the second chassis component 310, and corresponds to the bottom portion of the housing component 100. The second air outlet 310b is formed on another surface of the second chassis component 310, and corresponds to the upper portion of the housing component 100. The second mechanical component 311 is disposed in the second chassis component 310, and is connected to the processing assembly 32 and the second heat-generating component 211. The second mechanical component 311 is configured to control the second heat-generating component 211 to provide the second electromagnetic field. The second heat dissipation component 312 is disposed in the second chassis component 310, and is connected to the processing assembly 32. The second heat dissipation component 312 corresponds to the second air outlet 310b and another one of the ventilation openings 112a. The second heat dissipation component 312 is configured to provide the heat dissipation airflow to the corresponding ventilation opening 112a. Here, the first mechanical component 301 and the second mechanical component 311 can be electromagnetic induction heating controllers or other types of heating control modules, and the first heat dissipation component 302 and the second heat dissipation component 312 can be fan modules.

Hence, when the first cooking surface 101a of the seat assembly 10 carries the at least one food ingredient F, and the cover assembly 20 covers the seat assembly 10, the first cooking surface 101a and the second cooking surface 201a clamp and heat the at least one food ingredient F.

For example, when the double-sided heating apparatus Z of the present disclosure is in operation (as shown in FIG. 1 to FIG. 7), a user firstly manipulates the handle support 20010 of the cover assembly 20 to move the cover assembly 20 away from the seat assembly 10 (i.e., pushing the cover assembly 20 upward, such that the second cooking surface 201a is away from the first cooking surface 101a). At this time, a predetermined angle DA (e.g., between 60 degrees and 90 degrees) is defined between the second cooking surface 201a and the first cooking surface 101a. The predetermined angle DA is preferably 70 degrees or 75 degrees, but is not limited thereto. After the food ingredient F to be cooked is placed on the first cooking surface 101a, the handle support 20010 of the cover assembly 20 is once again manipulated by the user to cover the seat assembly 10 with the cover assembly 20 (i.e., pressing the cover assembly 20 downward, such that the second cooking surface 201a is adjacent to the first cooking surface 101a). Accordingly, the first cooking surface 101a and the second cooking surface 201a are attached to two surfaces of the food ingredient F. Furthermore, the user can operate the two processing assemblies 32 of the control module 3 (which can be, for example, rotating or touching the processing assemblies 32, but is not limited thereto), so as to respectively set a heating temperature of the first heating assembly 11 and that of the second heating assembly 21.

It is worth mentioning that the outer housing 2000 is movably connected to the side supports 20011 by being connected to the connection members 20014 via the first connection points 2000a, and is movably and correspondingly connected to the slide openings 20011a via the second connection points 2000b at the two sides thereof. As such, when the cover assembly 20 covers the seat assembly 10, and the second cooking surface 201a is pressed against the food ingredient F, the outer housing 2000 is capable of timely adjusting an angle of the second cooking surface 201a (i.e., a small degree of rotation) due to the first connection points 2000a acting as its fulcrum and movable displacement of the second connection points 2000b at the slide openings 20011a. In this way, the second cooking surface 201a can be in a horizontal state relative to the first cooking surface 101a (i.e., the second cooking surface 201a is almost parallel to the first cooking surface 101a), thereby allowing the second cooking surface 201a to horizontally press and fully contact the surface of the food ingredient F and enabling the two surfaces of the food ingredient F to be uniformly heated.

According to the operation of the user or a built-in application, the processing assembly 32 obtains an execution instruction (which can be, for example, information of the heating temperature, but is not limited thereto), so as to control the first driving assembly 30 for driving the first heat-generating component 111 to generate the first electromagnetic field and control the second driving assembly 31 for driving the second heat-generating component 211 to generate the second electromagnetic field. Then, the first heat-generating component 111 can drive the first griddle component 101 to quickly generate the heat energy by electromagnetic induction, such that the first griddle component 101 is heated and the heat energy is transmitted to one surface of the food ingredient F. On the other hand, the second electromagnetic field generated by the second heat-generating component 211 can drive the second griddle component 201 to quickly generate the heat energy by electromagnetic induction, such that the second griddle component 201 is heated and the heat energy is transmitted to another surface of the food ingredient F. Afterwards, the double-sided heating apparatus Z can be used to fry and cook the food ingredient F via the first cooking surface 101a and the second cooking surface 201a. It is worth mentioning that, in the double-sided heating apparatus Z of the present disclosure, the first thermal insulation component 110 is disposed between the first griddle component 101 and the first heat-generating component 111, and the second thermal insulation component 210 is disposed between the second griddle component 201 and the second heat-generating component 211. Accordingly, the first thermal insulation component 110 and the second thermal insulation component 210 can achieve effects of heat blocking and thermal insulation. The heat generated by the first griddle component 101 and the second griddle component 201 does not easily dissipate, and damages to parts or a shortened service life of the parts can also be prevented as the heat energy is not transmitted to the inside of the base module 1 and the hot-pressing module 2.

During the process of frying or cooking the food ingredient F by the double-sided heating apparatus Z, through placement of the shielding member 1003 on the base module 1, grease or cracklings can be prevented from splattering outside of the double-sided heating apparatus Z. In addition, the grease, the cracklings, or other dregs produced by the food ingredient F can be discharged to the collection member 1004 at the bottom portion of the main housing 1000 via the guide opening 1000b and the guide channel structure 1000a.

When the double-sided heating apparatus Z of the present disclosure is being operated, according to the operation of the user or the built-in application, the processing assembly 32 can further drive the first heat dissipation component 302 and the second heat dissipation component 312 to operate. The first heat dissipation component 302 performs suction via the first air inlet 300a, and draws gas outside of the first chassis component 300 into the first chassis component 300, so as to form a heat dissipation airflow CA and perform heat dissipation on the first mechanical component 301 (i.e., a first heat dissipation effect). In the meantime, the heat dissipation airflow CA is discharged outside of the first chassis component 300 via the first air outlet 300b. The discharged heat dissipation airflow CA flows to the first heat-generating component 111 via the ventilation opening 112a, and performs heat dissipation on the first heat-generating component 111 (i.e., a second heat dissipation effect). On the other hand, the second heat dissipation component 312 performs suction via the second air inlet 310a, and draws gas outside of the second chassis component 310 into the second chassis component 310, so as to form the heat dissipation airflow CA and perform heat dissipation on the second mechanical component 311. In the meantime, the heat dissipation airflow CA is discharged outside of the second chassis component 310 via the second air outlet 310b. The discharged heat dissipation airflow CA flows to the second heat-generating component 211 via the ventilation opening 112a, and performs heat dissipation on the second heat-generating component 211.

Through the above-mentioned technical solution, the double-sided heating apparatus Z of the present disclosure can use the first heating assembly 11 and the second heating assembly 21 to heat and cook the two surfaces of the food ingredient F by electromagnetic heating, such that a cooking process and cooking time of the food are shortened, and heating and cooking efficiencies are enhanced. Compared with a conventional heating tube, the electromagnetic induction coil adopted in the first heating assembly 11 and the second heating assembly 21 has a longer service life and is more durable. Furthermore, in the double-sided heating apparatus Z of the present disclosure, the second cooking surface 201a can be in full contact with the surface of the food ingredient F through the structural design of the hot-pressing module 2, thereby allowing the two surfaces of the food ingredient F to be uniformly heated. Moreover, through the structural design of the first heating assembly 11, the first driving assembly 30, and the second driving assembly 31, the double-sided heating apparatus Z of the present disclosure can perform heat dissipation on internal parts of the base module 1 twice, so as to improve heat dissipation efficiency.

As shown in FIG. 2 to FIG. 7, the base module 1 of the present disclosure can further include a first sensing assembly 12. The first sensing assembly 12 is disposed on the seat assembly 10, and is connected to the processing assembly 32. The first sensing assembly 12 is configured to sense a temperature of the first cooking surface 101. Here, the first sensing assembly 12 can be a temperature sensor, and can be disposed on the first griddle component 101. In addition, the hot-pressing module 2 can further include a second sensing assembly 22. The second sensing assembly 22 is disposed on the cover assembly 20, and is connected to the processing assembly 32. The second sensing assembly 22 is configured to sense a temperature of the second cooking surface 201a. Here, the second sensing assembly 22 can be a temperature sensor, and can be disposed on the second griddle component 201. Furthermore, the control module 3 can further include at least one display assembly 33. The display assembly 33 is disposed on the seat assembly 10, and is connected to the processing assembly 32. The display assembly 33 can be a liquid-crystal display, or other types of displays. In the present embodiment, the quantity of the display assembly 33 is exemplified to be two, but is not limited thereto. The processing assembly 32 is configured to drive the display assemblies 33 to display at least one temperature message according to one or both of a result of the first sensing assembly 12 sensing the temperature of the first cooking surface 101a and a result of the second sensing assembly 22 sensing the temperature of the second cooking surface 201a. Here, the at least one temperature message can be numbers, characters, or a combination thereof.

When the double-sided heating apparatus Z of the present disclosure is heating the two surfaces of the food ingredient F by the first cooking surface 101a and the second cooking surface 201a, the first sensing assembly 12 and the second sensing assembly 22 can be simultaneously and respectively used to detect the temperature of the first cooking surface 101a and that of the second cooking surface 201a. In addition, the display assemblies 33 are used to display detection data of the first sensing assembly 12 and the second sensing assembly 22 in real time. During the heating process of the food ingredient F by the double-sided heating apparatus Z, the user can decide whether to increase, decrease, or maintain the heating temperature according to the temperature message displayed by the display assemblies 33 at different time points.

As shown in FIG. 2 and FIG. 5 to FIG. 7, the seat assembly 10 of the present disclosure can further include at least one heat removal component 102. The heat removal component 102 is embedded in the rear housing plate 1002 of the housing component 100, and is connected to the processing assembly 32 of the control module 3. The heat removal component 102 is configured to draw and discharge gas in the first accommodating space 100a outside of the housing component 100. Specifically, the heat removal component 102 can be a fan module, and is disposed opposite to the processing assembly 32. In the present embodiment, the quantity of the heat removal component 102 is exemplified to be two, but is not limited thereto. Hence, when the double-sided heating apparatus Z of the present disclosure is in operation (i.e., after being activated), the processing assembly 32 controls the heat removal components 102 to operate, such that the gas (which includes the heat dissipation airflow CA with the heat energy) in the first accommodating space 100a is suctioned and discharged outside of the housing component 100. In this way, the heat dissipation efficiency of the double-sided heating apparatus Z can be improved.

However, the aforementioned examples describe only one of the embodiments of the present disclosure, and the present disclosure is not intended to be limited thereto.

### Second Embodiment

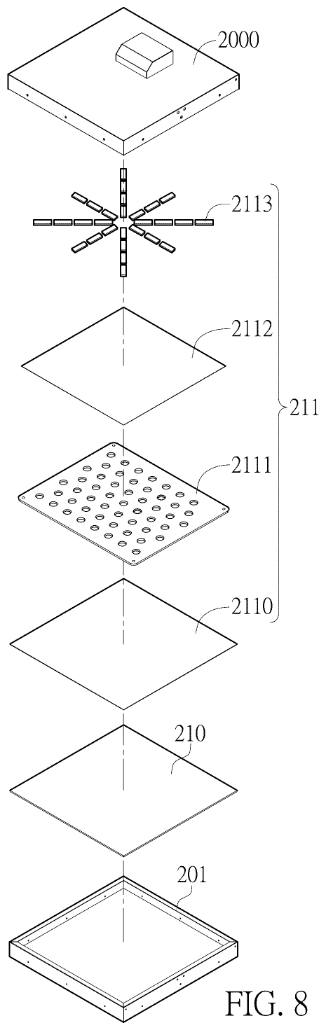

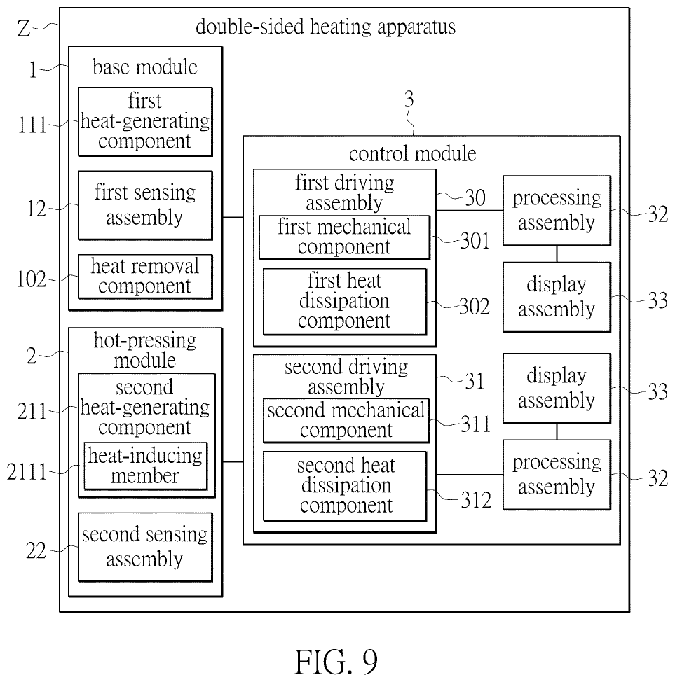

Referring to FIG. 8 and FIG. 9, which are to be read in conjunction with FIG. 1 to FIG. 7, FIG. 8 is a partial schematic exploded view of the hot-pressing module of the double-sided heating apparatus according to a second embodiment of the present disclosure, and FIG. 9 is a functional block diagram of the double-sided heating apparatus according to the second embodiment of the present disclosure. As shown in the figures, the double-sided heating apparatus Z of the present embodiment is substantially similar to that of the previous embodiment. As such, configurations or actuations of the same assemblies will not be reiterated herein. Different from the double-sided heating apparatus Z of the previous embodiment, the second heat-generating component 211 of the double-sided heating apparatus Z in the present embodiment includes a first blocking member 2110, a heat-inducing member 2111, a second blocking member 2112, and a plurality of magnetic members 2113. The first blocking member 2110 is disposed on a surface of the second thermal insulation component 210. The heat-inducing member 2111 is disposed on a surface of the first blocking member 2110 that faces away from the second thermal insulation component 210. The heat-inducing member 2111 is connected to the second driving assembly 31, and is configured to provide the second electromagnetic field. The second blocking member 2112 is disposed on a surface of the heat-inducing member 2111 that faces away from the first blocking member 2110. The magnetic members 2113 are disposed on a surface of the second blocking member 2112 that faces away from the heat-inducing member 2111.

In other implementations (as shown in FIG. 3, FIG. 4, and FIG. 6 to FIG. 9), the second heat-generating component 211 of the present disclosure includes the first blocking member 2110, the heat-inducing member 2111, the second blocking member 2112, and the magnetic members 2113. The first blocking member 2110 and the second blocking member 2112 can each be a mica plate or a plate structure made of other similar materials. The heat-inducing member 2111 can be an electromagnetic heating assembly, and can include a heating coil and a copper plate, or an electromagnetic induction plate. The magnetic member 2113 can be a magnetic bar structure. The heat-inducing member 2111 is disposed between the first blocking member 2110 and the second blocking member 2112, and the first blocking member 2110 is disposed between the heat-inducing member 2111 and the magnetic members 2113.

Hence, when the double-sided heating apparatus Z of the present disclosure is being operated, and the processing assembly 32 controls operation of the second driving assembly 31, the second driving assembly 31 can drive the heat-inducing member 2111 to generate the second electromagnetic field. Then, the second electromagnetic filed generated by the heat-inducing member 2111 can drive the second griddle component 201 to generate the heat energy by electromagnetic induction, such that the second griddle component 201 is heated and the heat energy is transmitted to another surface of the food ingredient F.

However, the aforementioned examples describe only one of the embodiments of the present disclosure, and the present disclosure is not intended to be limited thereto.

### Third Embodiment

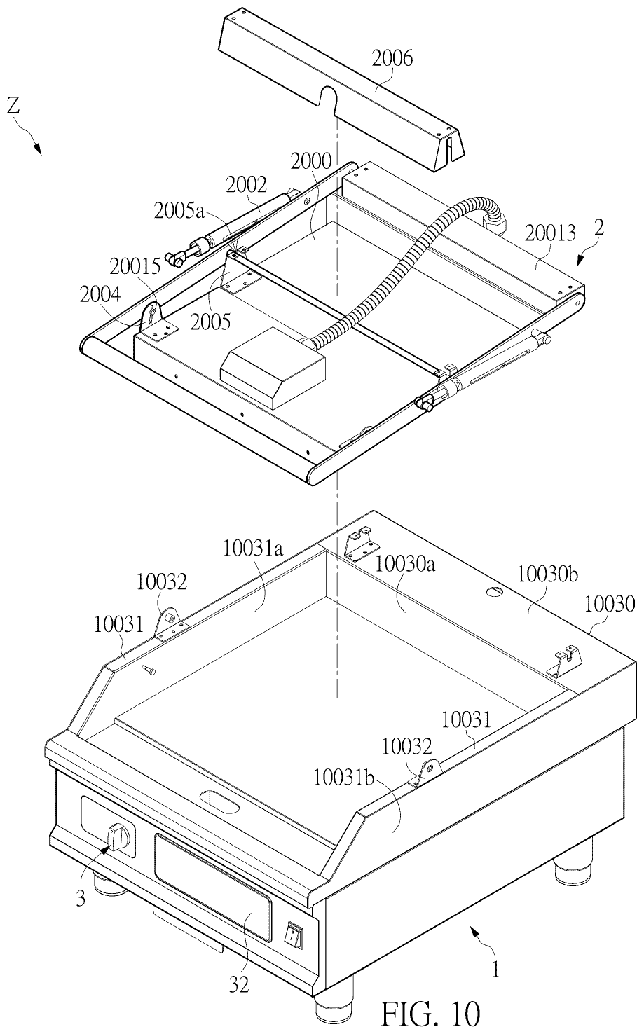

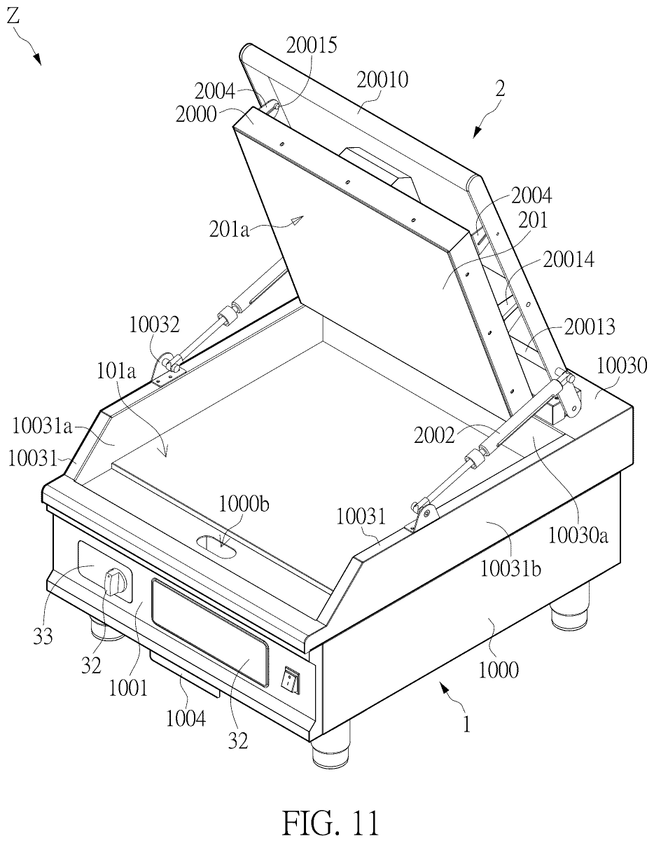

Referring to FIG. 10 and FIG. 11, which are to be read in conjunction with FIG. 1 to FIG. 9, FIG. 10 is a partial schematic exploded view of the hot-pressing module of the double-sided heating apparatus according to a third embodiment of the present disclosure, and FIG. 11 is a schematic view showing a use status of the double-sided heating apparatus according to the third embodiment of the present disclosure. As shown in the figures, the double-sided heating apparatus Z of the present embodiment is substantially similar to those of the previous embodiments. As such, configurations or actuations of the same assemblies will not be reiterated herein. The double-sided heating apparatus Z of the present embodiment is different from those of the previous embodiments in that the shielding member 1003 of the present embodiment includes a center portion 10030 and a plurality of side flange portions 10031. Referring to FIG. 1 to FIG. 9, one of the side flange portions 10031 is connected to one side of the center portion 10030, and another one of the side flange portions 10031 is connected to another side of the center portion 10030. Each side flange portion 10031 has an inner side surface 10031a and an outer side surface 10031b. The center portion 10030 has an inner side surface 10030a and an upper side surface 10030b. The inner side surface 10030a of the center portion 10030 corresponds to (or is joined to) the inner side surface 10031a of each side flange portion 10031, and the upper side surface 10030b of the center portion 10030 is joined to the outer side surface 10031b of each side flange portion 10031. In addition, the connection support 20013 is connected to the upper side surface 10030b of the center portion 10030 (while the connection support 20013 of the previous embodiment is connected to the inner side surface 10030a of the center portion 10030). Accordingly, the user may conveniently clean the first cooking surface 101a and the shielding member 1003 in the double-sided heating apparatus Z of the present embodiment.

Referring to FIG. 1 to FIG. 9, the cover component 200 can further include a plurality of first limiting members 2004. The first limiting members 2004 are oppositely disposed on two sides of a surface of the outer housing 2000 that faces away from the second cooking surface 201a, and are adjacent to the handle support 20010. The frame 2001 can further include a plurality of positioning rods 20015. The positioning rods 20015 are each disposed on one of the side supports 20011, and are adjacent to the handle support 20010. Each positioning rod 20015 is movably connected to one of the first limiting members 2004. In addition, the cover component 200 can further include a plurality of second limiting members 2005 and a cover member 2006. The second limiting members 2005 are oppositely disposed on the two sides of the surface of the outer housing 2000 that faces away from the second cooking surface 201a, and are each disposed at a center position of the side. One end of each second limiting member 2005 is inwardly recessed to form a groove 2005a, and each groove 2005a is configured to accommodate the middle support 20012. The cover member 2006 is detachably connected to the second limiting member 2005. In the present disclosure, by clamping the middle support 20012 with the second limiting members 2005 and the cover member 2006, the outer housing 2000 can be movably connected to the frame 2001.

Referring to FIG. 1 to FIG. 9, the shielding member 1003 further incudes a plurality of positioning plates 10032. Each of the positioning plates 10032 is disposed on an edge of one of the side flange portions 10031, and another end of each support member 2002 is movably connected to one of the positioning plates 10032. In this way, the support members 2002 in the double-sided heating apparatus Z of the present embodiment can avoid or be in less contact with the heat generated by the first cooking surface 101a and the second cooking surface 201a, thereby prolonging the service life.

Referring to FIG. 1 to FIG. 9, the processing assembly 32 and the display assembly 33 of the present disclosure can also be integrated into one component (e.g., a touch screen), which can not only be used for controlling one or both of the first driving assembly 30 and the second driving assembly 31, but can also display the temperature message.

However, the aforementioned examples describe only one of the embodiments of the present disclosure, and the present disclosure is not intended to be limited thereto.

### Beneficial Effects of the Embodiments

In conclusion, in the double-sided heating apparatus Z provided by the present disclosure, by virtue of “the base module 1 including the seat assembly 10 and the first heating assembly 11, the seat assembly 10 having the first accommodating space 100a and the first cooking surface 101a, and the first cooking surface 101a being configured to carry the at least one food ingredient F,” “the first heating assembly 11 being disposed in the first accommodating space 100a, the first heating assembly 11 corresponding to the first cooking surface 101a, and the first heating assembly 11 being configured to drive the first cooking surface 101a to generate the heat energy,” “the hot-pressing module 2 including the cover assembly 20 and the second heating assembly 21, the cover assembly 20 being movably connected to the seat assembly 10, the cover assembly 20 having the second accommodating space 200a and the second cooking surface 201a, and the second cooking surface 201a corresponding to the first cooking surface 101a,” “the second heating assembly 21 being disposed in the second accommodating space 200a and connected to the control module 3, the second heating assembly 21 corresponding to the second cooking surface 201a, and the second heating assembly 21 being configured to drive the second cooking surface 201a to generate the heat energy,” “the control module 3 being connected to the first heating assembly 11 and the second heating assembly 21, and the control module 3 being configured to control one or both of the first heating assembly 11 and the second heating assembly 21 to actuate,” and “the first cooking surface 101a and the second cooking surface 201a clamping and heating the at least one food ingredient F when the first cooking surface 101a of the seat assembly 10 carries the at least one food ingredient F and the cover assembly 20 covers the seat assembly 10,” the heating and cooking efficiencies can be enhanced.

Through the above-mentioned technical solution in which the first heating assembly 11 is disposed on the base module 1 and the second heating assembly 21 is disposed on the hot-pressing module 2, the double-sided heating apparatus Z of the present disclosure can heat and cook the two surfaces of the food ingredient F by electromagnetic heating, such that the cooking process and the cooking time of the food are shortened, and the heating and cooking efficiencies are enhanced. Compared with the conventional heating tube, the electromagnetic induction coil adopted in the double-sided heating apparatus Z of the present disclosure has a longer service life and is more durable. Furthermore, in the double-sided heating apparatus Z of the present disclosure, the first cooking surface 101a and the second cooking surface 201a can be in full contact with the two surfaces of the food ingredient F through the structural design of the hot-pressing module 2 and cooperation with the base module 1, thereby allowing the two surfaces of the food ingredient F to be uniformly heated. Moreover, through the structural design of the first heating assembly 11, the first heat dissipation component 302, and the second heat dissipation component 312, the double-sided heating apparatus Z of the present disclosure can perform heat dissipation on the internal parts of the base module 1 twice, so as to improve the heat dissipation efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A double-sided heating apparatus, comprising:
a base module, wherein the base module includes:
a seat assembly having a first accommodating space and a first cooking surface, wherein the first cooking surface is configured to carry at least one food ingredient; and
a first heating assembly disposed in the first accommodating space, wherein the first heating assembly corresponds to the first cooking surface, and is configured to drive the first cooking surface to generate heat energy;
a hot-pressing module, wherein the hot-pressing module includes:
a cover assembly movably connected to the seat assembly, wherein the cover assembly has a second accommodating space and a second cooking surface, and the second cooking surface corresponds to the first cooking surface; and
a second heating assembly disposed in the second accommodating space, wherein the second heating assembly corresponds to the second cooking surface, and is configured to drive the second cooking surface to generate heat energy; and
a control module connected to the first heating assembly and the second heating assembly, wherein the control module is configured to control one or both of the first heating assembly and the second heating assembly to actuate;
wherein, when the first cooking surface of the seat assembly carries the at least one food ingredient, and the cover assembly covers the seat assembly, the first cooking surface and the second cooking surface clamp and heat the at least one food ingredient.

2. The double-sided heating apparatus according to claim 1, wherein the control module includes:
a first driving assembly connected to the first heating assembly, wherein the first driving assembly is configured to control the first heating assembly for driving the first cooking surface to generate the heat energy;
a second driving assembly connected to the second heating assembly, wherein the second driving assembly is configured to control the second heating assembly for driving the second cooking surface to generate the heat energy; and
at least one processing assembly connected to the first driving assembly and the second driving assembly, wherein, according to an execution instruction, the at least one processing assembly is configured to control one or both of the first driving assembly and the second driving assembly for respectively driving the first heating assembly and the second heating assembly to actuate.

3. The double-sided heating apparatus according to claim 2, wherein the first heating assembly includes:
a first thermal insulation component corresponding to the first cooking surface;
a first heat-generating component connected to the first driving assembly, wherein the first heat-generating component is configured to provide a first electromagnetic field for driving the first cooking surface to generate the heat energy; and
a first carrier component, wherein the first carrier component is configured to carry the first heat-generating component;
wherein the first heat-generating component is disposed between the first thermal insulation component and the first carrier component.

4. The double-sided heating apparatus according to claim 3, wherein the first carrier component has a plurality of ventilation openings, and the ventilation openings correspond to the first heat-generating component;
wherein the first driving assembly includes:
a first mechanical component connected to the at least one processing assembly and the first heat-generating component, wherein the first mechanical component is configured to control the first heat-generating component to provide the first electromagnetic field; and
a first heat dissipation component connected to the at least one processing assembly, wherein the first heat dissipation component corresponds to one of the ventilation openings, and is configured to provide a heat dissipation airflow to the one of the ventilation openings;
wherein the second driving assembly includes:
a second mechanical component connected to the at least one processing assembly and the second heating assembly, wherein the second mechanical component is configured to control the second heating assembly for driving the second cooking surface to generate the heat energy; and
a second heat dissipation component connected to the at least one processing assembly, wherein the second heat dissipation component corresponds to another one of the ventilation openings, and is configured to provide the heat dissipation airflow to the another one of the ventilation openings.

5. The double-sided heating apparatus according to claim 2, wherein the second heating assembly includes:
a second thermal insulation component corresponding to the second cooking surface;
a second heat-generating component connected to the second driving assembly, wherein the second heat-generating component is configured to provide a second electromagnetic field for driving the second cooking surface to generate the heat energy; and
a second carrier component, wherein the second carrier component is configured to carry the second heat-generating component;
wherein the second heat-generating component is disposed between the second thermal insulation component and the second carrier component.

6. The double-sided heating apparatus according to claim 5, wherein the second heat-generating component includes:
a first blocking member disposed on a surface of the second thermal insulation component;
a heat-inducing member disposed on a surface of the first blocking member that faces away from the second thermal insulation component, wherein the heat-inducing member is connected to the second driving assembly, and is configured to provide the second electromagnetic field;
a second blocking member disposed on a surface of the heat-inducing member that faces away from the first blocking member; and
a plurality of magnetic members disposed on a surface of the second blocking member that faces away from the heat-inducing member.

7. The double-sided heating apparatus according to claim 2, wherein the base module further includes a first sensing assembly, the first sensing assembly is disposed on the seat assembly and connected to the at least one processing assembly, and the first sensing assembly is configured to sense a temperature of the first cooking surface;
wherein the hot-pressing module further includes a second sensing assembly, the second sensing assembly is disposed on the cover assembly and connected to the at least one processing assembly, and the second sensing assembly is configured to sense a temperature of the second cooking surface;
wherein the control module further includes a display assembly, and the display assembly is disposed on the seat assembly and connected to the at least one processing assembly;
wherein the at least one processing assembly is configured to drive the display assembly to display at least one temperature message according to one or both of a result of the first sensing assembly sensing the temperature of the first cooking surface and a result of the second sensing assembly sensing the temperature of the second cooking surface;
wherein the at least one temperature message is numbers, characters, or a combination thereof.

8. The double-sided heating apparatus according to claim 1, wherein the seat assembly includes a housing component and a first griddle component, the housing component has the first accommodating space, the first griddle component is embedded in the housing component, and a surface of the first griddle component is the first cooking surface; wherein the cover assembly includes a cover component and a second griddle component, the cover component has the second accommodating space and is movably connected to the seat assembly, the second griddle component is connected to the cover component, and a surface of the second griddle component is the second cooking surface.

9. The double-sided heating apparatus according to claim 8, wherein the cover component includes:
an outer housing having the second accommodating space, wherein the outer housing is connected to the second griddle component;
a frame movably connected to the outer housing; and
a plurality of support members, wherein one end of each of the support members is connected to the frame, and another end of each of the support members is connected to the housing component.

10. The double-sided heating apparatus according to claim 8, wherein the seat assembly further includes at least one heat removal component, the at least one heat removal component is embedded in the housing component and connected to the control module, and the at least one heat removal component is configured to draw and discharge gas in the first accommodating space outside of the housing component.
